(19) United States
(12) Patent Application Publication
(10) Pub. No.: US 2013/0032298 A1
(43) Pub. Date: Feb. 7, 2013

(54) AUTOMATED METHOD FOR WASTE DEHYDRATION RATE ASSESSMENT THROUGH CONDENSATE MONITORING

(71) Applicants: Michael D. Putt, Robesonia, PA (US); Steven M. Eno, Lancaster, PA (US); Shaun A. Leid, Ephrata, PA (US)

(72) Inventors: Michael D. Putt, Robesonia, PA (US); Steven M. Eno, Lancaster, PA (US); Shaun A. Leid, Ephrata, PA (US)

(21) Appl. No.: 13/533,544

(22) Filed: Jun. 26, 2012

Related U.S. Application Data
(60) Provisional application No. 61/513,705, filed on Aug. 1, 2011.

(51) Int. Cl. B01D 1/30; B01D 1/00

(52) U.S. Cl. 159/23; 159/47.3; 159/44

(57) ABSTRACT

A system and method for providing operational control to a dehydration unit involves monitoring a rate of liquid extraction from material in the unit. The volumetric flow rate of condensate from air extracted from the dehydrating unit may be monitored and used to control operation of the dehydrating unit, particularly termination of the heating process of the dehydrating unit.

### CROSS-REFERENCE

This application claims the benefit of U.S. Provisional Application Ser. No. 61/513,705, filed Aug. 1, 2011, the entirety of which is incorporated herein by reference.

### TECHNICAL FIELD

The present application relates generally to the field of dehydration units and their operational control. More specifically, the present application relates to a control system and method for a dehydration unit where the control system monitors the volumetric flow rate of condensate from the dehydrating unit and controls operation of the dehydrating unit based on the volumetric flow rate.

### BACKGROUND

In general terms, a dehydration unit, as used herein, is a device that imparts heat to a material in a substantially closed environment such that the moisture or liquid present in the material is driven out or released from the material into the surrounding air. The released liquid, in the form of liquid vapor in the air, is then channeled away from the material to a condensation unit where the liquid vapor is condensed into a liquid and the liquid is discharged from the unit. The result of the dehydration process using the dehydration unit is a material with substantially less liquid, e.g., water, content than was present in the material before processing by the dehydration unit.

Although variations exist, a dehydration unit generally comprises a tub or vessel where the liquid-containing material is initially placed, a sealable lid or cover which when in a closed position, provides a substantially closed environment within the tub, a heat source for applying heat to the tub, and means for cycling the enclosed air through a condensation unit. In various embodiments, the dehydration unit may also contain additional features such as an auger or paddle arrangement within the tub which causes movement of the material inside the dehydration unit to facilitate liquid release. Dehydration units are also found in various sizes, and therefore, dehydration units may differ widely with respect to the amount of material the unit is able to process.

With regard to operational controls, some dehydration units are designed to “run” for a predetermined amount of time. In other words, after material is placed in the dehydration unit, the sealable lid closed, and a “run” or dehydration operation initiated, the dehydration unit will “run” for the selected or designed amount of time, after which, the dehydration unit powers down. A “run”, as used herein, refers to the operational status of the dehydration unit where heat is applied to the material within the dehydration unit.

A drawback of the operational control of dehydration units is that the length of a “run” time is independent of the state of dehydration of the material within the dehydration unit. Put another way, the dehydration unit will run for its predetermined amount of time regardless of whether there is a maximal or a lesser amount of material in the dehydration unit. Similarly, the dehydration unit will run for its predetermined amount of time regardless of the amount of liquid present in a material to be treated. This operational control method not only results in wasted time, as an unnecessarily long run period delays the ability of a dehydration unit to process another batch of material, but also wastes energy by unnecessary prolonged heating of the material, and therefore, is not cost effective.

Other dehydration units monitor the temperature of the thermal oil contained in a jacket surrounding the dehydration vessel. In these units, the temperature reading is used to bring the thermal oil up to desired temperature, and maintain the specified temperature throughout the dehydration cycle via processor control, such as a proportional—integral—derivative controller (PID controller), which is a generic control loop feedback system. As exhibited by PID control loops, when the temperature set point is reached the heat is turned off until the oil temperature drops a predetermined amount from the set point. The heaters are then turned back on and continue to cycle in the described manner until the process is complete. Manufacturers have claimed to monitor the amount of time elapsed when reheating the oil from its low temperature point back to the set point, and used this elapsed time as an indication of the dryness of the material. Generally, this form of control is believed to be based upon the understanding that moist material will conduct heat at a higher rate than dry material. Therefore, if the time elapsed during the reheat cycle doesn't exceed a minimum amount of time set in the machine controls, the material is no longer absorbing heat at the desired amount and is considered dry. However, this form of instrumentation has proven to be unreliable and dependent upon the properties of the material being processed and the amount of product being processed.

Thus, there is a need for a dehydration unit control system which is able to alter a run time based on input providing an accurate reflection of the status of the dehydration process.

### SUMMARY

In one aspect, a monitoring and control system for a dehydration unit is provided that monitors the rate of liquid extraction from a material and responsively controls the operation of the dehydration unit.

In one embodiment of the foregoing aspect, the monitoring and control system comprises a condenser, a condensate collection tank having an inlet in fluid communication with the condenser and an outlet, wherein the condensate collection tank collects condensate from the condenser. A sensor mounted on, or otherwise associated with, the condensate collection tank is capable of indicating when the condensate reaches a defined state, such as a full state or other level within the tank. A valve is mounted on the outlet of the condensate collection tank and capable of switching between closed and open states. Alternatively, a pump capable of switching between on and off states, or another flow control device may be used. A controller is connected in communication with the sensor, the valve or pump, and a dehydration unit. The controller is configured such that, upon receiving an indication of the defined state of the condensate collection tank from the sensor, the controller signals the valve to open or pump to run for a period of time sufficient to allow the condensate collection tank to empty, and after this time, signaling to the valve to close or pump to stop. The controller is configured to calculate or otherwise determine an interval time between successive indications of the defined state of the condensate collection tank, and is capable of storing and comparing a preset interval time with the calculated interval time. Based on the comparison of the calculated and preset interval times, the controller provides a signal to the dehydration unit terminating a heating process in the dehydration unit.

In another aspect, a control sub-assembly of a dehydration unit is provided which modifies the operation of the dehydration unit. Specifically, the control sub-assembly provides operational control of a dehydration unit by monitoring the volumetric flow rate of condensate from the dehydrating unit.

In one embodiment of the foregoing aspect, the control sub-assembly system for the dehydration unit comprises a condensate collection tank having an inlet in fluid communication with a condenser and an outlet, wherein the condensate collection tank collects condensate from the condenser. A sensor mounted on, or otherwise associated with, the condensate collection tank is capable of indicating when the condensate reaches a defined level within the tank. A valve mounted on the outlet of the condensate collection tank can be switched between closed and open states for draining the collection tank. As an alternative to the valve, a pump or other flow control device may be used. A controller in communication with the sensor, the valve or pump, and a dehydration unit, wherein the controller, upon receiving an indication of condensate reaching the defined level, signals the valve to open or pump to run for a period of time sufficient to allow the condensate collection tank to empty, and after this time, signaling to the valve to close or pump to stop so that the collection tank can begin collecting condensate again. The controller is programmed or otherwise configured to determine an interval time between successive indications of a full state of the condensate collection tank as a technique for monitoring volumetric flow rate of condensate. The controller is capable of storing and comparing preset interval times with the determined interval times. Based on the comparison of the calculated and preset interval times, the controller provides a signal to the dehydration unit terminating a heating process in the dehydration unit.

In another embodiment of the foregoing aspect, the control sub-assembly system includes a condensate collection tank having an inlet to receive condensed liquid, a sensor for indicating when condensed liquid collected in the condensate collection tank reaches a defined level and a flow control device for controlling draining of the condensate collection tank. A controller is in communication with the sensor and the flow control device. The controller is configured to (i) operate the flow control device so as to allow the condensate collection tank to repeatedly fill to defined level and drain and (ii) provide a dehydration unit heating process terminate signal when a time period for the condensate collection tank to fill to the defined level exceeds a set threshold time.

In yet another aspect, a method of monitoring and controlling the operation of a dehydration unit based upon the rate of liquid extraction from the material in the dehydration unit is provided. In one embodiment, the method comprises monitoring a volumetric flow rate of a condensate from a condenser in fluid communication with a dehydration unit, and based on the monitored volumetric flow rate, controlling the operation of a heating process of the dehydration unit.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a schematic representation of the described system according to one embodiment.

FIGS. 2A-2D show one embodiment of the condenser and collection tank arrangement.

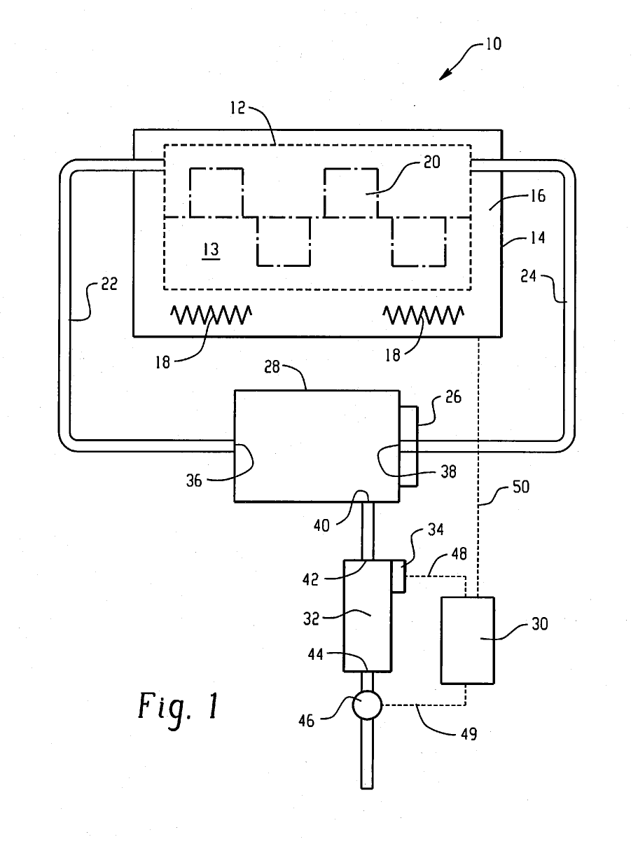

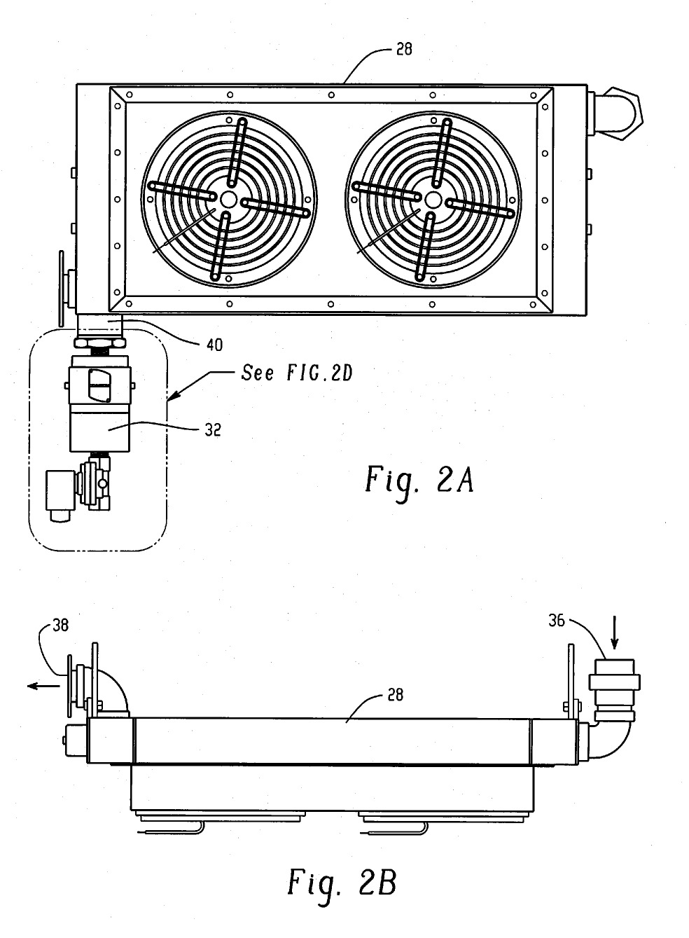

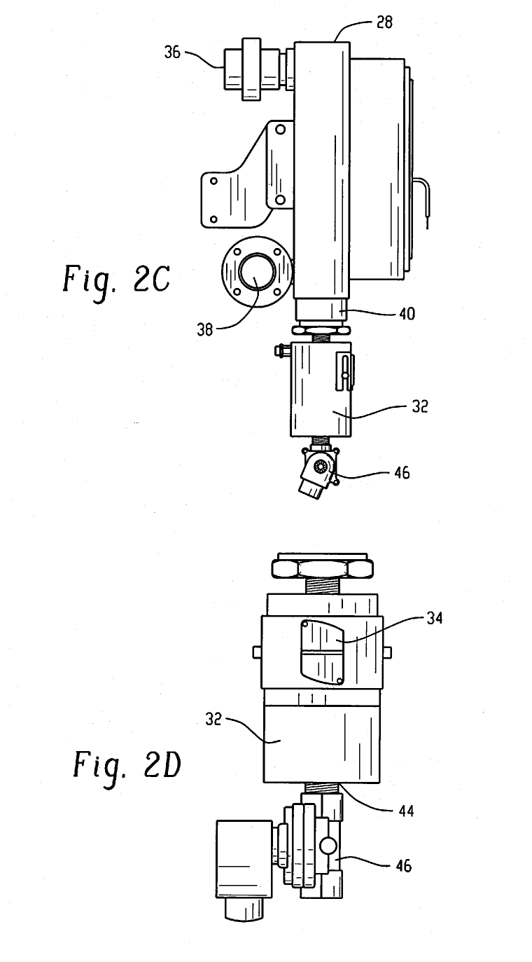

### DETAILED DESCRIPTION

A dehydration unit 10 generally includes of an enclosed vessel 12, which is surrounded, at least partially, by a jacket 14 that provides a space 16 containing a bed of heat transfer oil. The interior chamber 15 of the vessel 12 may be accessible via an access door (not shown) that can be closed during processing. During the dehydration process, the heat transfer oil is heated in the jacket (e.g., by immersion heaters 18) to a temperature set in the dehydration controller. Heat transferred from the jacket space 16 into the vessel brings the process material up to temperatures necessary for liquids to be removed, e.g., evaporated, from the material. In some cases, the material is agitated by a mixing paddle 20 throughout the duration of the dehydration process to help ensure consistent temperatures throughout the material and facilitate evaporation of the liquid. A closed loop air circuit, including paths 22 and 24, powered by a blower 26, moves saturated or moist air from the vessel via path 22 into and through a condenser 28 to remove liquid vapor. In some cases, after the air passes through the condenser 28, the exited, dry air is reheated by an immersion heater (not shown) mounted in the circuit before the dry air reenters the vessel via path 24. The heating of the dry air helps to eliminate odor and increases the moisture carrying capacity of the air in the vessel.

As described in detail below, the liquid, e.g., water, collected in the condenser 28 is used to monitor the dryness of the material. Once the material is deemed dry, the heaters are turned off but the blower 26 may continue to cycle air from the vessel 12 through the condenser 28 for cooling so as to bring the material to a safe handling temperature. In some cases, once the material is safe to handle, the material is automatically discharged from the vessel by reversing the rotation of the mixing paddles.

A monitoring and control system for a dehydration unit is thereby provided that monitors the rate of liquid extraction from a material and responsively controls the operation of the dehydration unit.

The monitoring and control system includes condenser 28, a controller 30, a condensate collection tank 32, a sensor 26, and a flow control device 46, such as a valve or pump. The condenser 28 is in fluid communication with an interior chamber 13 of the dehydration unit 10 via the above-mentioned air circuit, such that saturated air from the interior chamber 13 enters the condenser 28 via an inlet port 36. Following condensation of the liquid vapor in the saturated air by the condenser 28 to result in non-saturated or dry air, the non-saturated or dry air exits the condenser 28 via an outlet port 38 and returns to the interior chamber 13 of the dehydration unit 10. In general, the condenser 28 provides a means for cooling the entering, saturated air to result in the liquid vapor condensing into a liquid. The condensed liquid, e.g., water, falls to the bottom portion of the condenser 28 where it exits the condenser via a condenser liquid outlet 40, which is connected to the condensate collection tank 32.

The condensate collection tank 32, which may be mounted under the condenser 28, captures the liquid draining from the condenser 28 and includes an inlet 42 for receiving liquid from the condenser 28, an outlet or drain 44 that has an associated flow control device 46 (e.g., a valve or pump) to control whether liquid is drained from the tank. The sensor 34 is provided for determining when a target volume of condensate has been reached in the condensate collection tank 32. The condensate collection tank 32 accommodates a determined or known volume of liquid. In various embodiments, the volume of the condensate collection tank 32 may be set or varied depending on the material-handling capacity of a particular dehydration unit 10 to which the described monitoring and control system is applied. In one embodiment, the condensate collection tank 32 is suitable for a Somat model DH 100, and monitors condensate flow in intervals of 300 ml to 700 ml (e.g., about 500 ml), but variations are possible.

When a target volume of condensate in the condensate collection tank 32 is reached, e.g., the volume of the condensate collection tank 32 or a defined level within the tank, the sensor 26 (e.g., a level sensor of any suitable type (e.g., capacitive, optical etc.)), sends a signal to controller 30 via electrical connection 48, indicating that the target volume has been reached. The sensor 34 may be mounted on or in the condensate collection tank 32 such that the sensor 34 is able to indicate when the condensate in the condensate collection tank 32 has reached the target volume.

Upon receiving a signal from the sensor 34 indicating that the target volume in the condensate collection tank 32 has been reached, the controller 30, such as a programmable logic controller (PLC), operates the flow control device 46 (e.g., opens the valve (e.g., a solenoid valve) or turns the pump on) at the outlet 44 of the condensate collection tank 32 via electrical connection 49. The flow control device 28 is operated for an amount of time sufficient to allow the condensate collection tank 32 to drain. After the condensate collection tank 32 has emptied, e.g., after a predetermined amount of time, the controller 30 ceases operation of the flow control device 28 (e.g., closes the valve or stops the pump), and the condensate collection tank 32 can once again collect the condensate. The process repeats each time the sensor 34 indicates that the condensate in the condensate collection tank 32 has reached the target volume.

The volumetric flow rate of condensation from the dehydration unit 10 is quantified by programming the controller 30 to monitor the amount of time it takes for the condensate collection tank 32 to fill. For example, the controller 30 monitors the elapsed time between empty and target volume conditions. When the elapsed time between tank full conditions exceeds a predetermined time interval, where the predetermined time interval is also programmed into the controller 30, the material in the dehydration unit 10 is determined to be dry and a signal is sent from the controller 30 via electrical connection 50 to dehydration unit 10 to terminate the heating process. In this manner, the controller is able to terminate the heating process when the volumetric flow rate of liquid extraction from the processed material falls to a threshold level, but the threshold low level need not be calculated or determined by the controller. That is, the controller determines that extraction has fallen to the threshold level based upon the time to fill the condensate collection tank 32. In various embodiments, the time interval set in the controller is adjustable, and may be tailored to a particular waste stream, for example, a material which has a high liquid content.

In another aspect, existing dehydration units can be modified to utilize the control feature. A control sub-assembly for a dehydration unit is provided which modifies the operation of the dehydration unit. Specifically, the control sub-assembly provides operational control of a dehydration unit by monitoring the volumetric flow rate of condensate from the dehydrating unit. In this aspect, the control sub assembly, including controller 30, condensate collection tank 32, sensor 34, and flow control device 28, described in detail above, is added to an existing dehydration unit 10 having a condenser 28, and allows efficient operation of the dehydration unit 10. Dehydration units may be augmented or supplemented with the control sub-assembly including, for example, dehydration units manufactured by Somat, Ecorect, and Gaia.

A method of monitoring and controlling the operation of a dehydration unit is provided by the above system. The method involves monitoring the rate of liquid extraction from the processed material by considering the volumetric flow rate of condensate from a condenser in fluid communication with a dehydration unit and, based on the volumetric flow rate of condensate, controlling the operation of the dehydration unit. The volumetric flow rate of condensate from a condenser may be monitored by recording the time interval required for the condensate to fill a collecting tank of known volume. The recorded time interval is compared to a stored time interval value such that, when the recorded time interval is greater than the stored time interval, a control signal is sent to a heating process within the dehydration unit to terminate the heating process. In some embodiments, a blower that circulates air between a vessel in the dehydration unit and a condenser is not terminated by the control signal that terminated the heating process, so as to provide cooling of the process material.

Other apparatus may be used to monitor the volumetric flow rate of liquid extraction from a material in order to responsively control the run time of the dehydration operation. For example,

Volumetric condensate flow rate determination, which reflects material or waste dehydration rate, provides an operational advantage over existing dehydration control technologies. Laboratory testing shows that the dehydration cycle; in terms of water removed per unit time, remains consistent regardless of load size. Thus, by monitoring the condensate volumetric flow rate, dehydration time, and the associated energy consumption, can be optimized as a function of the input material or load size. The dehydration process is made more intelligent by optimizing run time and energy consumption. In addition, the present system and method can also be useful for any similar operation or system where moisture is being removed during a process.

It is to be clearly understood that the above description is intended by way of illustration and example only, is not intended to be taken by way of limitation, and that other changes and modifications are possible. For example, embodiments in which the condensate collection tank and sensor are integrated into the condenser are possible.

What is claimed is:

1. A dehydration unit monitoring and control system comprising
a condenser;
a condensate collection tank in fluid communication with the condenser to receive and collect condensed liquid and having an outlet;
a sensor for indicating when the condensate in the condensate collection tank reaches a defined level;
a flow control device for controlling draining of the condensate collection tank; and
a controller in communication with the sensor, the flow control device, and a dehydration unit;
wherein the controller is configured such that, upon receiving from the sensor an indication of condensate reaching the defined level, the controller controls the flow control device for a period of time sufficient to allow the condensate collection tank to empty, and after this time, controls the flow control device to allow the condensate collection tank to again begin to fill, and wherein the controller is configured to effect termination of a heating process of the dehydration unit when an interval time between successive indications of condensate reaching the defined level exceeds a set threshold time.

2. The system of claim 2 wherein the controller is configured to store and compare the set threshold time with determined interval times, and based on the comparison, provide a signal to the dehydration unit terminating a heating process.

3. The system of claim 1 wherein the condensate collection tank is mounted below the condenser and connected to the condenser via condenser drain path.

4. The system of claim 3 wherein the sensor is mounted on or in the condensate collection tank.

5. The system of claim 1 wherein the dehydration unit comprises a vessel with a chamber for receiving material to be processed, and a jacket space surrounding at least part of the vessel and containing a medium for heating the vessel.

6. The system of claim 1 wherein the flow control device is one of a sensor that is opened and closed by the controller or a pump that is turned on and off by the controller.

7. A control sub-assembly system for use with a dehydration unit, comprising
a condensate collection tank having an inlet to receive condensed liquid;
a sensor for indicating when condensed liquid collected in the condensate collection tank reaches a defined level;
a flow control device for controlling draining of the condensate collection tank; and
a controller in communication with the sensor and the flow control device, wherein the controller is configured to (i) operate the flow control device so as to allow the condensate collection tank to repeatedly fill to defined level and drain and (ii) provide a dehydration unit heating process terminate signal when a time period for the condensate collection tank to fill to the defined level exceeds a set threshold time.

8. The system of claim 7 wherein the controller is configured to store and compare the set threshold time with determined fill time periods, and based on the comparison, produce the dehydration unit heating process terminate signal.

9. The system of claim 7 further comprising a condenser, wherein the condenser, condensate collection tank, sensor and flow control device comprise an integrated unit with the condensate collection tank mounted below the condenser and connected to the condenser via condenser drain path, the sensor is mounted on or in the condensate collection tank and the flow control device mounted below the condensate collection tank.

10. A method of monitoring and controlling the operation of a dehydration unit, the method comprising:
monitoring a rate of liquid extraction from material in a dehydration unit, and
based on the monitored rate, controlling the operation of a heating process of the dehydration unit.

11. The method of claim 10 wherein the monitoring involves monitoring a volumetric flow rate of liquid extraction.

12. The method of claim 11 wherein the monitoring includes condensing extracted liquid from air drawn from the dehydration unit and monitoring the condensed liquid.

13. The method of claim 12 wherein the monitoring of the volumetric flow rate comprises determining an interval time, wherein the interval time is the time required for condensate to reach a set volume within a condensate collecting tank.

14. The method of claim 13 wherein the interval time is compared to a preset time and controlling the operation of the heating process of the dehydration unit is based on the result of the comparison.

15. The method of claim 14 wherein when the interval time is greater than the preset time, a control signal is sent to shut-down the heating process within the dehydration unit.

16. The method of claim 10 wherein the monitoring involves sensing liquid extracted from material in the dehydration unit.
